(19) United States
(12) Patent Application Publication
(10) Pub. No.: US 2013/0058076 A1
(43) Pub. Date: Mar. 7, 2013

(54) LED Troffer

(71) Applicant: YaXi Ni, Lake Elsinore, CA (US)

(72) Inventor: YaXi Ni, Lake Elsinore, CA (US)

(21) Appl. No.: 13/337,318

(22) Filed: Dec. 27, 2011

Related U.S. Application Data
(60) Provisional application No. 61/530,023, filed on Sep. 1, 2011.

(51) Int. Cl. F21L 4/02; F21V 7/00; F21V 29/00

(52) U.S. Cl. 362/184

(57) ABSTRACT

A troffer style luminaire composed of multiple LED light engines, baffle assembly, power supply and power supply enclosure.

In addition, a LED light engine comprises an LED array, a three-sided heat sink element, light reflective sheets, end caps, and a luminous cover. Light reflective sheets are adhered onto inner sides of reflector. Luminous cover is coupled with end caps to form an interior space. The light emitted by the LED array is directed to the luminous cover or to light reflective sheets and then redirected to the luminous cover. All light through luminous cover is projected to desired environment.

### CROSS-REFERENCE TO RELATED APPLICATIONS

The present application claims priority to U.S. Provisional Application Ser. No. 61/530,023, filed Sep. 1, 2011.

### FIELD OF THE INVENTION

The invention relates to a troffer style luminaire, to a troffer for use with LED light source. In particular, this is directed to use one or more LED light engines to project the light to a wide area.

### BACKGROUND OF THE INVENTION

A luminaire is a light fixture typically composing light source and ballast. One of the most popular commercial luminaires is lay-in troffer for use in applications such as offices.

A troffer typically uses one or more fluorescent light tubes as light source, can include magnetic or electronic ballast(s). Also the troffer utilizes baffles and one or more polycarbonate covers, diffusers or louvers for directing light purpose.

The troffer is installed within a suspended ceiling grid system by replacing existing ceiling tiles to troffers. The troffer is commonly of sizes 2 foot by 2 foot, 2 foot by 4 foot, 1 foot by 4 foot and 1 foot by 1 foot.

The fluorescent based troffer has obvious disadvantages. Fluorescent light tubes are short in life time, typical 1 or 2 years. And fluorescent light tubes emit omnidirectional light in 360 degrees, which most of the light is wasted and not projected to desired area.

There are approaches on the market to utilize solid state light source to replace fluorescent light source in troffers.

One approach is to replace just the fluorescent light tube directly with an LED tubular lamp, while the wiring within the fixture is usually needed to be changed. Such an approach takes a lot of labor during replacing process, and might have risks of electrical shock and fire.

Another approach is to use equivalent sizes of baffle assembly (e.g., aluminum), a panel (typically polycarbonate material, e.g., light guide plate) and one or more LED arrays which are embedded in sides of the said baffle assembly. The panel will be illuminated by the LED light and direct the light to downside. In this approach, a lot of heat will be generated by LEDs, which will be transmitted through baffle assemblies to ceiling tiles. This might result in high temperatures on baffle assemblies and ceiling tiles, and would potentially start a fire. In addition, this approach is low in light efficacy.

Still other approaches use a whole large size PCB on which many LED are put and a troffer fixture. The disadvantage of such approaches is once one or more LED diodes stop working, the whole PCB shall be removed and repaired, which is time-consuming, complicated and inconvenient.

### SUMMARY OF THE INVENTION

It would be desirable to provide a troffer which can replace existing fluorescent troffers easily and quickly, involving less labor expense.

It would be desirable to provide a troffer which can be easily maintained when any LED emitter stops working, and wherein one LED stops working, others will not be affected.

It would be desirable to provide a troffer which can dissipate heat generated by LEDs efficiently.

In addition, it would be desirable to provide a troffer which can output the light at a wide beam angle to a large area.

In accordance with the present invention, there is provided a troffer adopting one or more LED engines; a baffle assembly made of metal material; and at least one power supply which is put in an enclosure.

The LED engine further comprises a three-sided heat sink element, an elongated luminous cover, an LED array, two light reflective sheets and two end caps. The luminous cover can be clear, frosted or stripped style. One or more LED engines are fixed onto a metal plate; the metal plate is placed into the baffle assembly.

The baffle assembly forms sizes of 2 foot by 2 foot, 2 foot by 4 foot, 1 foot by 4 foot and 1 foot by 1 foot, which fits ceiling panels.

### BRIEF DESCRIPTION OF DRAWINGS

FIG. 1 is the front view of the luminaire.

FIG. 2 is the back view of the luminaire.

FIGS. 3 and 4 are side views of the luminaire

FIG. 5 depicts the LED engine is clipped into the cut area on the metal plate.

FIG. 6 illustrates the metal plate is fixed into the baffle assembly.

FIGS. 7 and 8 are sectional views of the luminaire.

FIG. 9 is the exploded view of the luminaire.

FIG. 10 shows light reflection and distribution inside and outside the LED engine.

FIG. 11 is the exploded view of the power supply and enclosure.

### DETAIL DESCRIPTION OF PREFERRED EMBODIMENT

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “present invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The below disclosed subject matter is to be considered illustrative, and not restrictive, and the appended claims are intended to cover all such modifications, enhancements, and other embodiments which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The terminology used herein is for the purpose of describing particular embodiments only and is not intended to be limiting of the present inventive subject matter. As used herein, the singular forms “a”, “an” and “the” are intended to include the plural forms as well, unless the context clearly indicates otherwise.

It will be understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be further understood that, although the terms first, second, etc. may be used herein to describe various elements, these elements should not be limited by these terms. These terms are only used to distinguish one element from another. For example, a first region/layer could be termed a second region/layer, and, similarly, a second region/layer could be termed a first region/layer without departing from the teachings of the disclosure.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

In the drawings, the thickness of layers and regions are exaggerated for clarity. It will also be understood that when an element such as a layer, region or substrate is referred to as being “on” or “onto” another element, it may lie directly on the other element or intervening elements or layers may also be present. Like reference numerals refer to like elements throughout the specification.

Spatially relatively terms, such as “beneath,” “below,” “above,” “upper,” “top,” “bottom” and the like, may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, when the device in the figures is turned over, elements described as below and/or beneath other elements or features would then be oriented (rotated 90 degrees or at other orientations) and the spatially relative descriptors used herein interpreted accordingly. As used herein, “height” refers to a direction that is generally orthogonal to the faces of a substrate.

As noted above, the present invention relates to lighting devices which comprises heat sink elements, baffle assembly and LEDs.

The heat sink element can be made of any desired material or combination of materials, a wide variety of which are readily available to and known by persons skilled in the art. In general, all other considerations being equal, materials or composite materials having greater thermal conductivity are desired. Representative examples of suitable materials include extruded aluminum and cast aluminum, with extruded aluminum being more desirable in many cases. If desired, the heat sink element can include one or more materials dispersed in one or more other materials, e.g., where the dispersed materials are effective for carrying heat to a different region. (e.g., carbon nanotubes, diamond silvers, etc.)

The baffle assembly can be formed of any desired material or combination of materials, a wide variety of which are readily available to and known by persons skilled in the art. A representative example of a suitable material is aluminum, particularly where the baffle assembly is coupled to the heat sink, whereby the baffle assembly can provide additional heat sinking capabilities. Skilled artisans are familiar with a wide variety of ways of forming aluminum (and/or other materials) into desired shapes.

The LEDs are one type of solid state lighting emitters, and well-known to persons skilled in the art, and any of such LEDs can be employed according to the present invention.

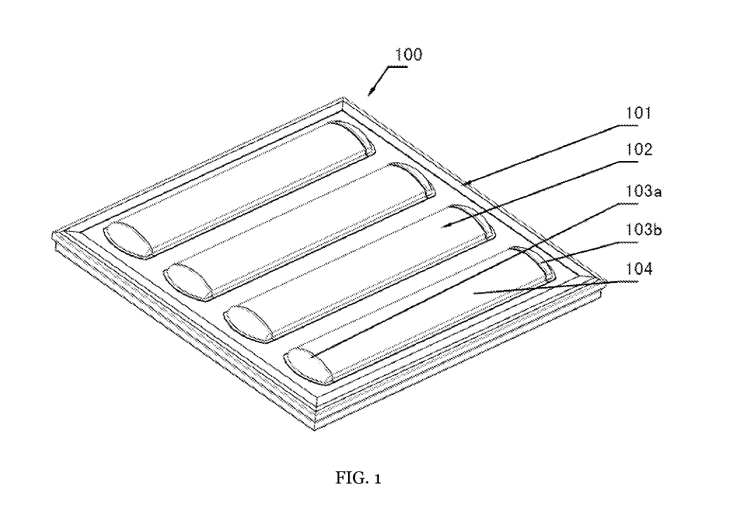

FIG. 1 is the front view of the luminaire 100 according to present invention. As seen in FIG. 1, the luminaire 100 includes one or more LED engines 102, a baffle assembly 101. The baffle assembly 101 has an overall dimension size to fit into conventional suspended ceiling grid system. As illustrated, the baffle assembly 101 is 2 foot by 2 foot size; however other sizes, 2 foot by 4 foot, 1 foot by 4 foot and 1 foot by 1 foot are also available. The LED engine 102 comprises a luminous cover 104 which is used to distribute light and a left end cap 103a and a right end cap 103b. The left end cap 103a and right end cap 103b may be provided in arc or rectangle shaped end.

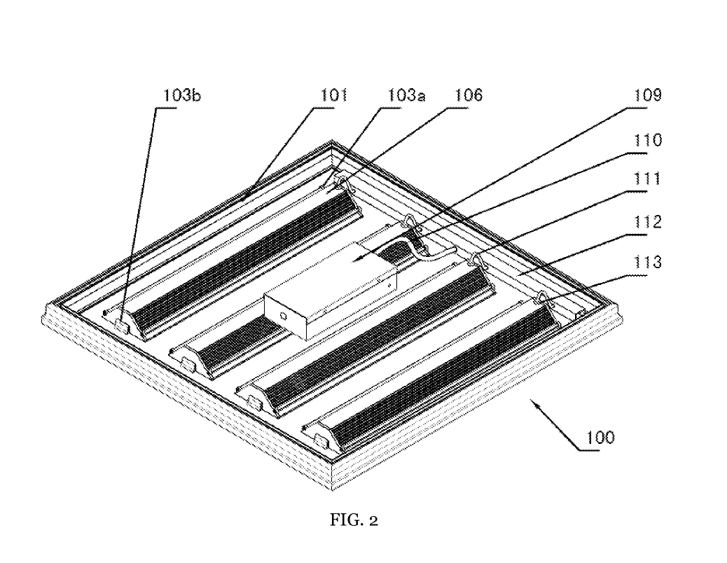

FIG. 2 is the back view of the luminaire 100. As seen in FIG. 2, the luminaire 100 further includes a power supply enclosure 109 on backside, which is connected by main electrical cable 110 to junction unit 112. Each LED engine 102 is connected into the junction unit 112 by electrical cable 111. Within the junction unit 112, every LED engine 102 is finally connected to main electrical cable 110. The LED engine 102 further comprises a three-sided heat sink element 106, whereon both exterior upper sides are with fins.

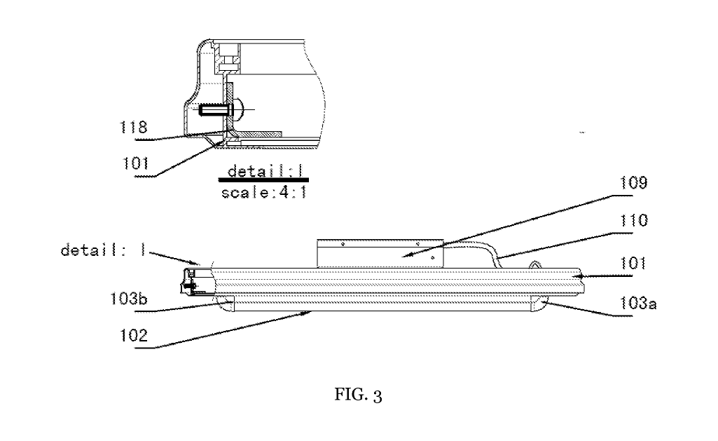

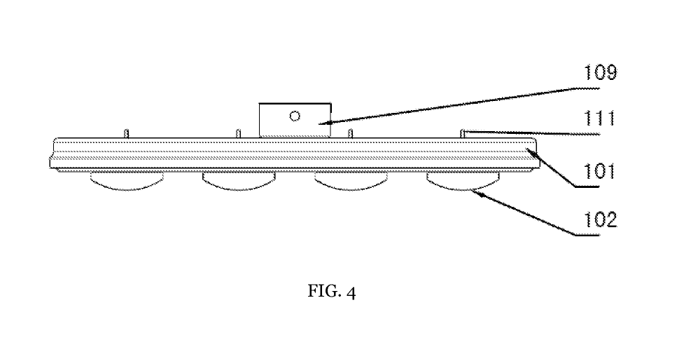

FIG. 3 and FIG. 4 provide additional side views of the luminaire 100 described above with reference to FIG. 1 and FIG. 2.

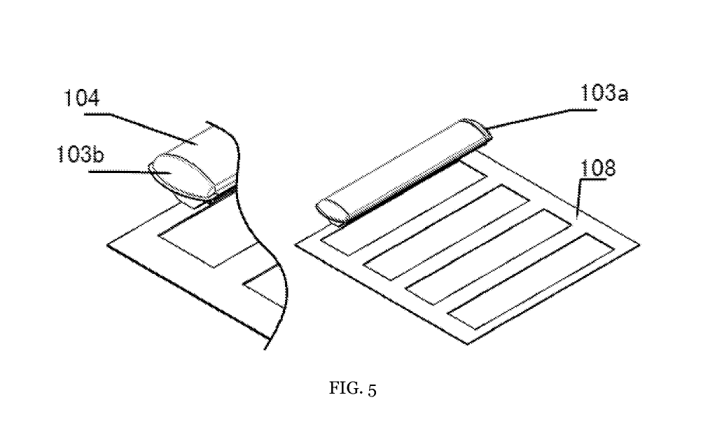

FIG. 5 illustrates the LED engine 102 is clipped into the cut area on the metal plate 108. The metal plate 108, for example, may be provided in aluminum, iron, copper or other heat conductive material. Different quantity of LED engines might be used for different size luminaire. For example, as illustrated in FIG. 5, a 2 foot by 2 foot size luminaire comprises four LED engines 102.

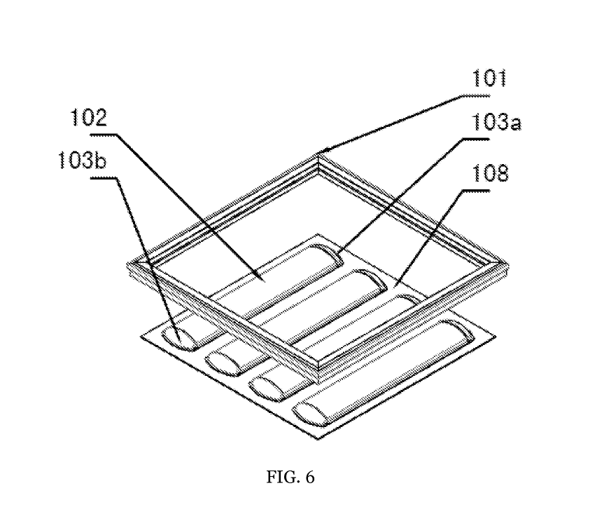

FIG. 6 shows the metal plate 108 mounted with four LED engines 102 are fixed into the baffle assembly 101.

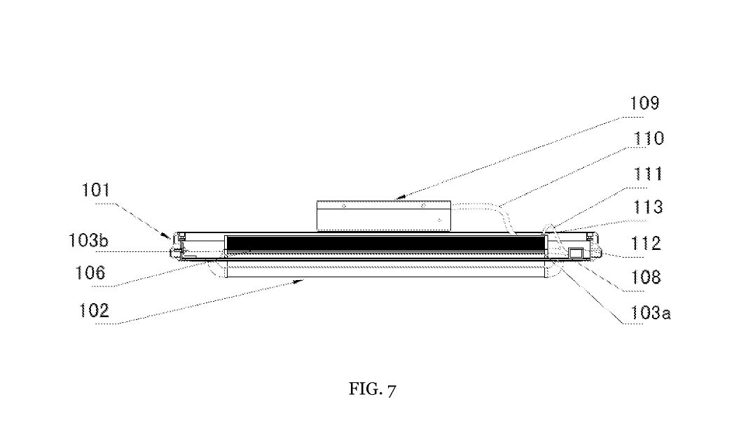

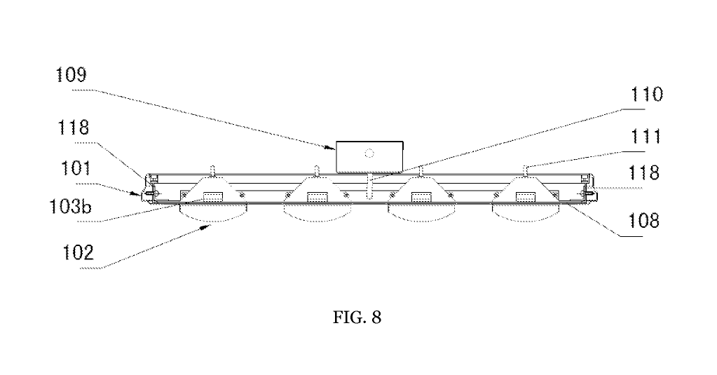

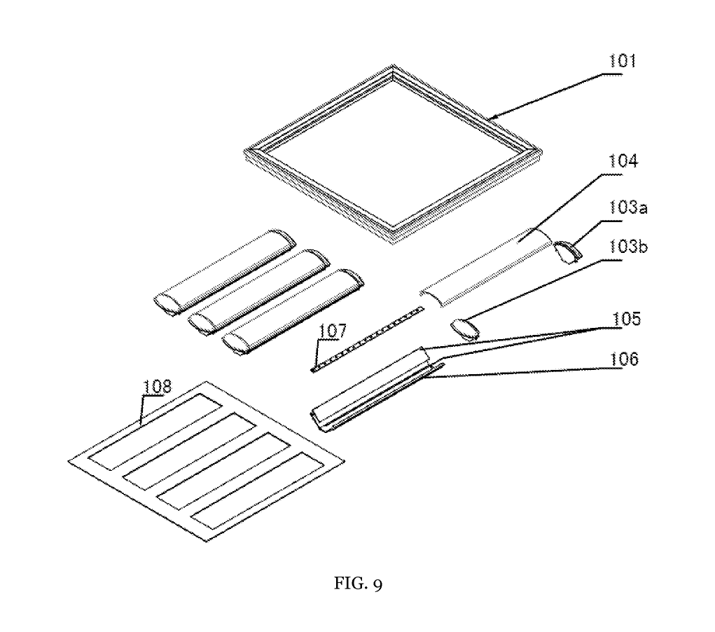

FIG. 7 through 9 are more detailed cross-sectional and exploded views of luminaire 100. As illustrated in FIG. 8, an additional mounting bracket 118 will be used to fix the metal plate 108 with LED engines 102 mounted on each inside corner of the baffle assembly 101.

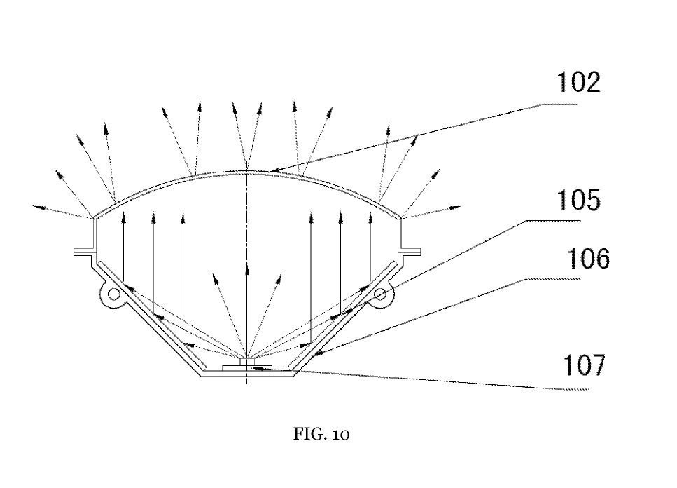

FIG. 10 further illustrates the configuration of the LED engine 102. As seen in FIG. 10, the LED engine 102 comprises a luminous cover 104, two pieces of light reflective sheets 105, a heat sink element 106 and an LED array 107. The luminous cover 104 may, for example, be provided as an acrylic, polycarbonate, PET, PETG or other lighting transmissive material. Furthermore, the luminous cover 104 may be provided in stripped style (a diffusing structure to distribute light to a wide angle), clear style (a transparent looking to maximumly distribute light out to the environment), or frosted style (a milky looking to distribute light smoothly).

The light reflective sheets 105 are adhered onto two interior upper sides. Thus light emitted by LEDs will be reflected and directed onto luminous cover 104. The heat sink element 106 is of three-sided shape. The bottom side is to mount LED array 107; the two upper sides are used to mount light reflective sheet 105. Each side might be provided with fins to dissipate heat more efficiently. The LED array 107 is mounted onto a metal core printed circuit board (PCB), and thermally coupled (by using thermal adhesive or other techniques known to those of skill in the art) or directly contacted to the heat sink element 106.

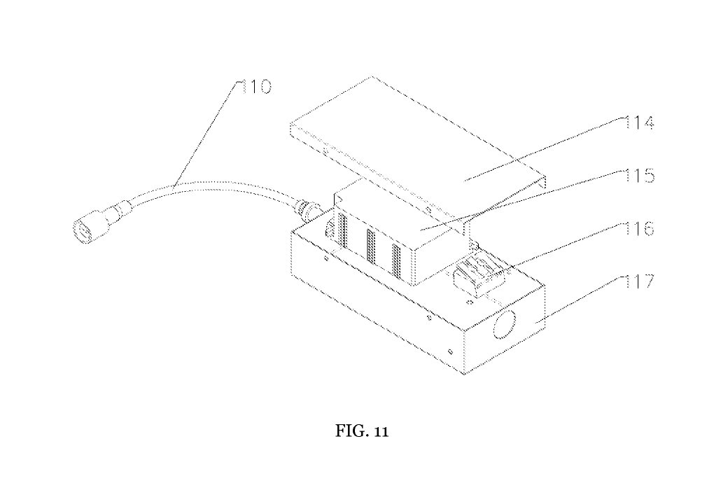

FIG. 11 further illustrates the internal configuration of the power supply enclosure 109. The enclosure 109 includes an upper cover 114 and a lower housing 117, and may be provided in any desired material (e.g. iron, ABS) or combination of materials. Furthermore, the enclosure 109 might be provided in square, circular or any other shape. A power supply 115 is put and mounted into the lower housing 117. The input of the power supply 115 is connected with a terminal 116 in which the mains are connected to; the output of the power supply 115 is connected with the electrical cable 110, which extends and connects to each LED engine 102. After the mains are connected well, the upper cover 114 shall be coupled onto lower housing 117 with screws.

What is claimed is:

1. A lighting fixture, comprising
one or more LED engines;
a baffle assembly made of metal material; and
at least one power supply which is put in an enclosure.

2. A lighting fixture as recited in claim 1, wherein the LED engine further comprises:
at least one LED array;
a three-sided heat sink element;
at least one light reflective sheet;
an elongated luminous cover; and
at least one end cap.

3. A lighting fixture as recited in claim 2, wherein the LED array comprises at least one LED.

4. A lighting fixture as recited in claim 2, wherein the LED array comprises a plurality of LED diodes.

5. A lighting fixture as recited in claim 3, wherein the LED is thermally coupled or directly contacted onto a metal core printed circuit board.

6. A lighting fixture as recited in claim 2, wherein the LED array is thermally coupled or directly contacted onto bottom side of the heat sink element.

7. A lighting fixture as recited in claim 2, wherein the outside of the heat sink element comprises fins.

8. A lighting fixture as recited in claim 2, wherein the two upper internal sides are adhered with at least one piece of light reflective sheet.

9. A lighting fixture as recited in claim 2, wherein the elongated luminous cover is clipped onto the heat sink element.

10. A lighting fixture as recited in claim 2, wherein the elongated luminous cover is of arc shape in sectional view.

11. A lighting fixture as recited in claim 2, wherein the end caps are coupled onto both sides of the heat sink element.

12. A lighting fixture as recited in claim 1, wherein the main frame further comprises a metal plate on which there is at least one cut.

13. A lighting fixture as recited in claim 2, wherein at least one LED engine is fixed into the cut area on the metal plate.

14. A lighting fixture as recited in claim 1, wherein the metal plate is then fixed into the baffle assembly.

15. A lighting fixture as recited in claim 1, wherein the power supply is put and configured into an enclosure.

16. A lighting fixture as recited in claim 15, wherein the power supply's output end is connected to each LED engines.

17. A lighting fixture as recited in claim 15, wherein the power supply's input end is connected to mains.
